(19) United States
(12) Patent Application Publication
(10) Pub. No.: US 2026/0360860 A1
(43) Pub. Date: Nov. 12, 2026

(54) Method and Apparatus for Operating a Battery Pack

(71) Applicant: Andreas Stihl AG & Co. KG, Waiblingen (DE)

(72) Inventors: Joachim Kolb, Weinstadt (DE); Florian Klein, Esslingen am Neckar (DE); Michael Fuchs, Waiblingen (DE); Christian Uhlmann, Erlangen (DE)

(73) Assignee: Andreas Stihl AG & Co. KG, Waiblingen (DE)

(21) Appl. No.: 19/668,965

(22) Filed: May 6, 2026

(30) Foreign Application Priority Data
May 8, 2025 (DE) 102025117652.3

(51) Int. Cl. H01M 10/6563; H01M 10/613; H01M 10/63; H01M 10/6569; H01M 50/218; H01M 50/24

(52) U.S. Cl. CPC H01M 10/6563; H01M 10/613; H01M 10/63; H01M 10/6569; H01M 50/218; H01M 50/24

(57) ABSTRACT

A method of operating a battery pack for providing energy is disclosed. The battery pack has an outer housing in which at least one battery cell is arranged. Heat is generated in the battery pack during operation. A cooling medium in a liquid phase is brought directly into contact with the outer housing of the battery pack so that heat from the battery pack vaporizes at least part of the cooling medium into a gaseous phase, thereby cooling the battery pack.

### CROSS-REFERENCE TO RELATED APPLICATION

This application claims the benefit of German Patent Application DE 102025117652.3, filed on May 8, 2025, the entire content of which is incorporated by reference.

### TECHNICAL FIELD

The disclosure relates to a method for operating a battery pack and to an apparatus for operating a battery pack.

### BACKGROUND

During operation, i.e., during the delivery of energy, during charging, or during discharging of a battery pack, heat is generated. This can adversely affect the operating conditions. Battery packs may therefore be cooled during operation. Typically, a blower and a cooling-air stream generated by the blower are provided for this purpose. Cooling with a liquid is also known from the prior art.

In CN 118 645 736 B, a battery pack inserted into a housing is cooled indirectly by spraying the outer wall of the housing with water. The water is circulated in a circuit.

### SUMMARY

The disclosure provides an improved method for operating a battery pack in such a way that the battery pack is efficiently cooled during operation.

The disclosure further provides an improved apparatus for operating a battery pack in such a way that efficient cooling of the battery pack is possible.

According to the method for operating, in particular for charging and/or discharging, a battery pack for providing energy, provision is made for a cooling medium in the liquid phase to be brought directly into contact with the battery pack, in particular with the outer housing of the battery pack, in such a way that at least part of the cooling medium vaporizes (transitions into a gaseous phase) due to the heat of the battery pack, whereby the battery pack is cooled. In particular, the cooling medium in the liquid phase is applied directly, at least partially, to the battery pack, in particular to the outer housing of the battery pack, in such a way that at least part of the cooling medium vaporizes due to the heat of the battery pack, whereby the battery pack is cooled. Alternatively or additionally, it can be provided that the cooling medium in the liquid phase is introduced at least partially directly into the battery pack in such a way that at least part of the cooling medium vaporizes due to the heat of the battery pack, whereby the battery pack is cooled.

By virtue of the fact that the liquid cooling medium is brought directly into contact with the battery pack, in particular with the outer housing of the battery pack, in such a way that at least part of the cooling medium vaporizes due to the heat of the battery pack, the energy for the phase transition of the cooling medium is withdrawn from the battery pack in the form of heat. Due to the heat withdrawn from the battery pack, the battery pack is cooled. By virtue of the fact that the liquid cooling medium is brought into contact directly, and not indirectly, with the battery pack, in particular with the outer housing of the battery pack, the heat is withdrawn from the battery pack efficiently. The cooling medium can rapidly absorb the heat of the battery pack to a large extent and evaporate rapidly. The battery pack is cooled rapidly. The battery pack is efficiently cooled during operation.

In particular, the cooling medium in the liquid phase is brought into contact with an outer surface of the outer housing of the battery pack in such a way that at least part of the cooling medium vaporizes due to the heat of the battery pack, whereby the battery pack is cooled. By application onto the outer surface of the outer housing, simple and rapid evaporation of the cooling medium is possible. In particular, the interior of the battery pack, in particular of the outer housing, can be cooled without coming into contact with the liquid cooling medium. The interior of the battery pack, in particular of the outer housing, in particular the battery cells, can thereby be protected from moisture. As a result, electrical contacts, connections, and/or terminals in the interior of the battery pack can be protected from moisture. The outer housing of the battery pack can be designed to be sealed outwardly against moisture.

Operation of the battery pack includes both the use of the battery pack for providing energy to a work apparatus and the charging and discharging, in particular without the energy being used for a work apparatus, of the battery pack. In particular, charging or discharging can take place in a work apparatus or in a charging device. Heat is generated during operation of the battery pack.

In particular, the cooling medium in the gaseous phase is discharged to the surrounding environment. As a result, the cooling effect is particularly efficient. The heat transferred from the battery pack to the cooling medium is carried away. It is reliably avoided that part of the heat is returned to the battery pack. In particular, the cooling medium does not circulate in a closed cooling system. As a result, no cooling measures need to be taken for the cooling medium. It can be discharged simply and efficiently to the surrounding environment.

In particular, the battery pack is arranged in or on a housing during operation. In particular, the cooling medium in the gaseous phase is conducted away from the housing. In this way, rapid and efficient cooling of the battery pack is possible in a simple manner.

In particular, the cooling medium in the gaseous phase is discharged to the surrounding environment by means of a blower. This enables rapid and efficient transport away of the heat withdrawn from the battery pack. In particular, the blower is arranged in the housing. The blower may also be configured to blow warm or heated air onto the battery pack. In this way, the drying process can be accelerated. Moreover, it is possible to condition, in particular to warm, the battery pack by means of the blower, for example before a charging operation.

In particular, after application of the liquid cooling medium, the battery pack is dried. This can take place, for example, by means of the blower. In particular, the battery pack is alternatively or additionally dried by the transition of the cooling medium into the gaseous phase. In this case, the cooling medium evaporates and leaves the battery pack. In particular, the drying process is completed. In particular, after completion of the drying process, the battery pack is completely dry. In particular, no cooling medium is then any longer present on the battery pack. As a result, corrosion of the battery pack by the cooling medium is avoided. In particular, the battery pack is initially brought into contact only with so much liquid cooling medium that the drying process is completed before the end of the, in particular complete, charging of the battery pack. In this way, efficient use of the cooling medium is possible. After charging of the battery pack, for example in a charging device, the battery pack can be used directly, for example for providing energy by the battery pack in a work apparatus.

In particular, alternatively or additionally to application onto the outer housing of the battery pack, the liquid cooling medium is applied directly to the at least one battery cell, in particular to a battery-cell housing, in particular through at least one through opening of the outer housing. In this way, particularly efficient cooling of the battery pack can take place at the location where the heat is generated. In particular, the at least one through opening also serves for entry of cooling air into the outer housing of the battery pack. In particular, the at least one through opening is a ventilation slot. In particular, the at least one through opening is closable, in particular by means of a closure element, in particular by means of a slider. In this way, the interior of the outer housing can be protected from undesired penetration of particles, dust, and/or moisture. There is the possibility of opening the at least one through opening only when this is actually desired, for example when cooling air and/or in particular liquid cooling medium is intended to enter the outer housing.

In particular, an outer surface of the battery pack, in particular of the outer housing, is hydrophilic. The outer surface of the battery pack, in particular the outer housing, may also be hydrophobic. Alternatively or additionally, the outer surface of the battery pack, in particular of the outer housing, is uneven, in particular structured, such that the outer surface serves as a large cooling surface. In particular, the outer surface is rough and not smooth. In particular, the arithmetical mean roughness value Ra of the outer surface (according to DIN EN ISO 4287 and DIN EN ISO 4288) is at least 0.8 µm, in particular at least 3 µm, in particular at least 5 µm, and in particular at most 15 µm.

In particular, the cooling medium is atomized before being applied to the battery pack. In this way, the cooling medium is distributed uniformly and finely on the battery pack. This enables rapid and efficient evaporation. The atomized particles of the cooling medium can readily and rapidly absorb the heat of the battery pack for the phase transition. This enables efficient cooling. In particular, the cooling medium is atomized by means of a nozzle or an ultrasonic evaporator. In particular, the cooling medium is applied to the battery pack in the form of a spray mist.

In particular, the battery pack satisfies at least protection class IPX3, in particular at least protection class IPX4, in particular at least protection class IPX5, in particular at least protection class IPX6, in particular at least protection class IPX7, in particular at least protection class IPX8, and in particular at least protection class IPX9K as defined in DIN EN 60529. The various protection classes make it possible, to different extents, for the liquid cooling medium to be brought directly into contact with the battery pack.

In particular, the battery pack has a rated voltage of at least 10 V, in particular at least 30 V. In particular, the battery pack alternatively or additionally has an energy capacity, in particular rated energy, of at least 70 Wh, in particular at least 140 Wh, in particular at least 180 Wh, in particular at least 250 Wh, and in particular at least 350 Wh. It is not known from the prior art that battery packs of this high power class are brought directly into contact with a liquid cooling medium for cooling purposes. Only the method and apparatus as disclosed herein enable such a configuration.

In a particularly advantageous further development of the invention, provision is made for a temperature of the battery pack to be determined. In particular, the cooling medium is brought into contact with the battery pack only when the temperature lies above a predetermined threshold temperature. In particular, alternatively or additionally, provision is made for the quantity of the cooling medium used for cooling to be adapted to the temperature of the battery pack. Because the cooling medium is applied only when a threshold temperature is exceeded, unnecessary cooling can be avoided. In this way, operation, in particular charging of the battery pack, can be accelerated. In particular, cooling medium can be saved. This also applies in the case where the quantity of cooling medium applied to the battery pack is adapted to the temperature. By these features, charging of the battery pack can be prepared rapidly and efficiently.

The apparatus for operating a battery pack is in particular a charging device for charging a battery pack and/or a work apparatus that can be supplied with energy by means of the battery pack. The apparatus has a coupling device, in the coupled state of which the battery pack is electrically coupled to the apparatus. The apparatus is designed for cooling the battery pack during operation. In particular, heat is generated during operation of the battery pack in the apparatus. The apparatus comprises a cooling-medium applicator. In the coupled state, a cooling medium in the liquid phase can be applied by means of the cooling-medium applicator directly onto the battery pack such that at least part of the cooling medium can evaporate into the gaseous phase due to the heat of the battery pack and the battery pack can thereby be cooled.

By virtue of the fact that the liquid cooling medium can be applied directly onto the battery pack such that at least part of the cooling medium vaporizes due to the heat of the battery pack, the energy for the phase transition of the cooling medium is withdrawn from the battery pack in the form of heat. Due to the heat withdrawn from the battery pack, the battery pack is cooled. By virtue of the fact that the liquid cooling medium can be applied directly, and not indirectly, onto the battery pack, the heat is withdrawn from the battery pack efficiently. The cooling medium can rapidly absorb the heat of the battery pack to a large extent and evaporate rapidly. The battery pack is cooled rapidly. Efficient cooling of the battery pack is made possible.

In particular, the battery pack has an outer housing in which at least one battery cell is arranged. Advantageously, in the coupled state, the cooling medium in the liquid phase can be applied directly by means of the cooling-medium applicator onto the outer housing of the battery pack. By application onto the outer surface of the outer housing, simple and rapid evaporation of the cooling medium is possible. In particular, the interior of the battery pack, in particular of the outer housing, can be cooled without coming into contact with the liquid cooling medium. The interior of the battery pack, in particular of the outer housing, in particular the battery cells, can thereby be protected from moisture. As a result, electrical contacts, connections, and/or terminals in the interior of the battery pack can be protected from moisture. The outer housing of the battery pack can be designed to be sealed outwardly against moisture.

Operation of the battery pack includes both the use of the battery pack for providing energy to the apparatus and the charging and discharging, in particular without the energy being used for the apparatus, of the battery pack in the apparatus.

In particular, the cooling-medium applicator is a nozzle, in particular a water nozzle, in particular an atomizer. It may also be provided that the cooling-medium applicator is a sprinkler nozzle or an ultrasonic evaporator.

In particular, the apparatus comprises a housing. In particular, the cooling-medium applicator is arranged on or in the housing. In particular, the battery pack is arranged in or on the housing in the coupled state. In a particular further development of the apparatus, the apparatus is designed such that the cooling medium in the gaseous phase can be discharged from the housing into the environment surrounding the apparatus, in particular completely. In this way, the cooling effect is particularly efficient. The heat delivered from the battery pack to the cooling medium is transported away. It is reliably avoided that part of the heat is returned to the battery pack. In particular, the cooling medium does not circulate in a closed cooling system. As a result, no cooling measures need to be taken for the cooling medium. It can be discharged simply and efficiently to the surrounding environment.

In particular, the apparatus comprises a blower. The cooling medium in the gaseous phase can be discharged into the surrounding environment by means of the blower. In particular, the blower is arranged in the housing.

In particular, after application of the liquid cooling medium by means of the cooling-medium applicator, the battery pack can be dried by the blower. In particular, the blower promotes detachment of the cooling medium from the battery pack and ensures rapid transport away of evaporated cooling medium. As a result, the battery pack is dried rapidly.

In particular, the apparatus comprises a control unit. In particular, the apparatus is designed such that, in the coupled state, the control unit receives information concerning the state of charge of the battery pack and the temperature of the battery pack. From the state of charge and the temperature, the control unit determines a maximum volume of cooling medium which at most may be applied to the battery pack such that the battery pack, in particular under the action of the blower, is completely dry before it is fully charged or fully discharged. In particular, the control unit controls the cooling-medium applicator such that it applies the determined maximum volume of cooling medium onto the battery pack. In this way, efficient use of the cooling medium is possible. In this way, corrosion of the battery pack due to the cooling medium is avoided. After charging of the battery pack, the battery pack can, in particular when the apparatus is a charging device, be used directly, for example for providing energy by the battery pack in a work apparatus. It may also be provided that complete drying of the battery pack during charging of the battery pack in an apparatus configured as a work apparatus takes place as described. In this way, the battery pack, in particular the work apparatus, can be used again immediately after complete charging of the battery pack. In this way, short circuits caused by the cooling medium are reliably avoided. Less dust and dirt adhere to a dry battery pack, which facilitates use in a work apparatus.

The apparatus can be further developed by the features stated for the method. The corresponding further developments are associated with the advantages stated for the method.

In particular, the cooling medium is water, in particular deionized water, or ethanol, or a liquid based on water or ethanol. Mixtures of different liquids are likewise conceivable. It is likewise conceivable to add additives to the cooling medium, in particular an antifreeze agent, in order to permit operation at low temperatures.

### BRIEF DESCRIPTION OF THE DRAWINGS

FIG. 1 shows a schematic side view of a first embodiment of an apparatus for operating a battery pack, configured as a charging device;

FIG. 2 shows a schematic side view of an alternative, second embodiment of an apparatus for operating a battery pack, configured as a charging device, wherein an outer housing of the battery pack has a through opening;

FIG. 3 shows a schematic side view of an alternative, third embodiment of an apparatus for operating a battery pack, configured as a charging device, wherein an outer surface of the battery pack is uneven; and

FIG. 4 shows a flow chart of a method for operating a battery pack.

### DETAILED DESCRIPTION

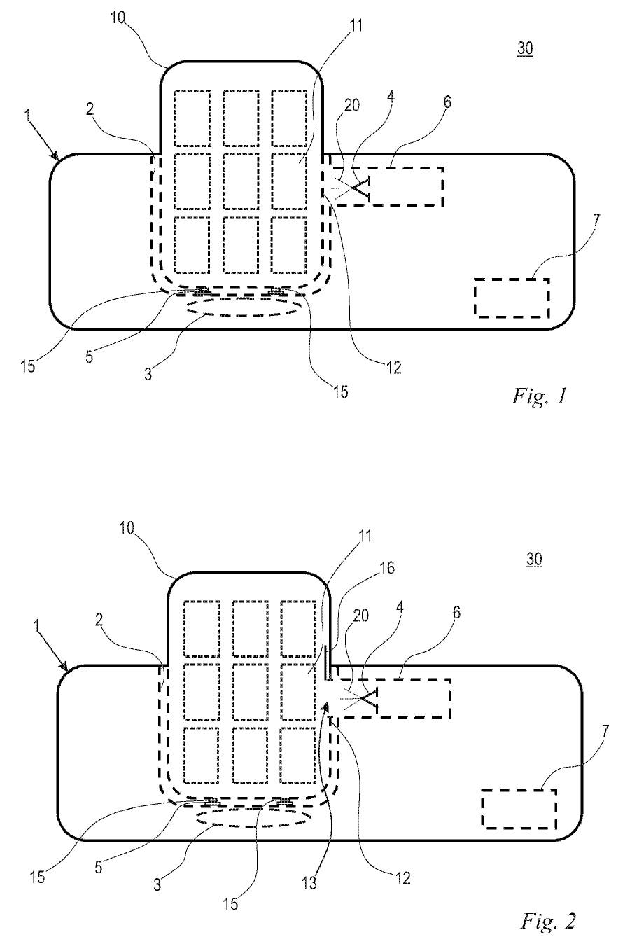

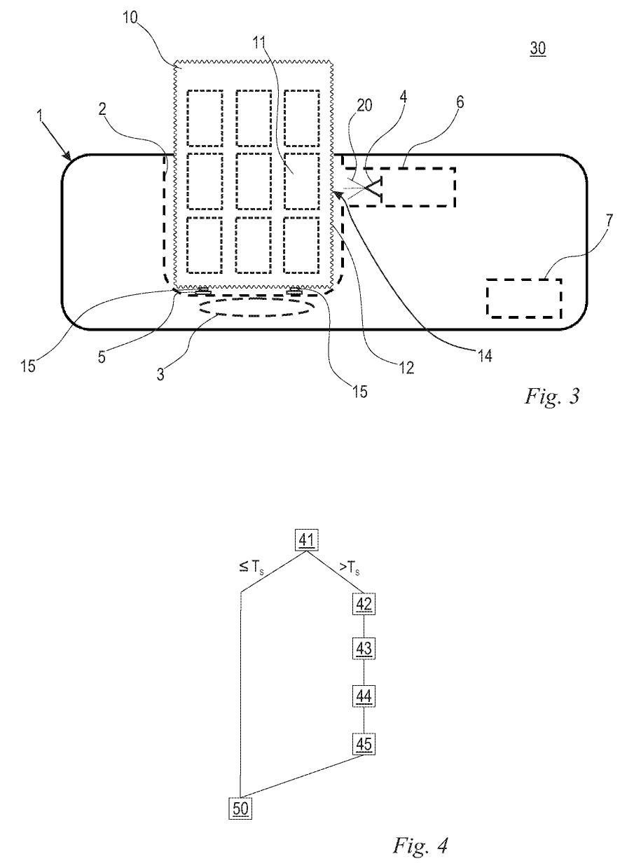

FIG. 4 shows, in a flow chart, the individual method steps of a method for operating the battery pack 10 illustrated in FIGS. 1-3. Operation of the battery pack 10 comprises both the use of the battery pack 10 for providing energy to a work apparatus and the charging and/or discharging of the battery pack 10.

The battery pack 10 comprises, as shown in FIGS. 1-3, at least one battery cell 11, and in the exemplary embodiments a plurality of battery cells 11. The battery cells 11 form a cell assembly. In all embodiments, the battery pack comprises an outer housing 12. The at least one battery cell 11 is arranged in the outer housing 12. The battery pack 10 serves for the storage of and/or as a source of electrical energy. The battery pack 10 is rechargeable. The battery pack 10 comprises at least two electrical contacts 15, in particular a positive terminal and a negative terminal, by means of which the battery pack 10 can be electrically connected to an apparatus 1.

The battery pack 10 has a rated voltage of at least 10 V, and in the exemplary embodiments of at least 30 V. The battery pack 10 has an energy capacity, in particular rated energy, of at least 70 Wh, in particular at least 140 Wh, in particular at least 180 Wh, in particular at least 250 Wh, and in particular at least 350 Wh.

The battery pack 10 satisfies at least protection class IPX3 as defined in DIN EN 60529. In the exemplary embodiments, the battery pack 10 satisfies at least protection class IPX8 as defined in DIN EN 60529.

In a first, optional method step 41 (FIG. 4), a temperature of the battery pack 10 is determined. If the temperature lies above a predetermined threshold temperature TS, the battery pack 10 is brought, in a third method step 43, into direct contact with a cooling medium 20 schematically illustrated in FIGS. 1-3. Here, the cooling medium 20 is at least partially applied directly onto the battery pack 10 (FIGS. 1 or 3) and/or introduced into the battery pack 10 (FIG. 2).

If the temperature is at most equal to the predetermined threshold temperature TS, the method is ended, which is symbolized in the flow chart according to FIG. 4 by reference sign 50. It may also be provided that the battery pack 10 is brought into contact with the cooling medium 20 without prior determination of the temperature. In this case, the method begins with the third method step 43.

After determination of the temperature in the first method step 41 and before application of the cooling medium 20 in the third method step 43, the quantity of the cooling medium 20 used for cooling can optionally be adapted, in a second method step 42, to the temperature of the battery pack 10. The quantity can be selected, for example, such that, upon charging, in particular complete charging, of the electrical energy of the battery pack 10, the cooling medium 20 evaporates completely and the battery pack 10 is subsequently dry.

In a fourth method step, the battery pack 10 is cooled in that at least part of the cooling medium 20 applied onto the battery pack vaporizes due to the heat of the battery pack 10. The latent heat of vaporization for this phase transition is withdrawn from the battery pack 10, thereby cooling the battery pack 10.

In the embodiment according to FIG. 1, the cooling medium 20 is applied directly onto the outer housing 12 of the battery pack 10 in the third method step 43. The cooling effect for the battery pack 10 can be improved in that an outer surface 14 of the battery pack 10, in particular of the outer housing 12 of the battery pack 10, is configured to be hydrophilic. In the embodiment according to FIG. 3, the outer surface 14 is additionally uneven, in particular structured. As a result, the outer surface 14 is enlarged in comparison with a planar surface and can receive a larger quantity of cooling medium 20, whereby the cooling effect is greater. In the embodiment according to FIG. 3, the outer surface 14 is rough and not smooth. The arithmetical mean roughness value Ra of the outer surface 14 (according to DIN EN ISO 4287 and DIN EN ISO 4288) is at least 0.8 µm, and in the embodiment at least 3 µm.

Alternatively or additionally, the cooling effect can be improved in that the cooling medium 20 is applied directly onto the at least one battery cell 11. In the embodiment according to FIG. 2, the outer housing 12 of the battery pack 10 has at least one through opening 13. The through opening 13 is closable by means of a closure element 16. In the embodiment, the closure element 16 is a slider. The liquid cooling medium 20 can be applied directly through the through opening 13 onto the at least one battery cell 11, in particular onto a battery-cell housing. Through the at least one through opening 13, the battery pack 10, in particular the at least one battery cell 11, can also alternatively or additionally be cooled by means of cooling air. The at least one through opening 13 is also referred to as a ventilation slot.

In the embodiments according to FIGS. 1-3, a cooling-medium applicator 6 is provided for application of the cooling medium 20 in the third method step 43 onto and/or into the battery pack 10. In the embodiments, the cooling-medium applicator 6 is a nozzle 4, in particular a water nozzle, in particular an atomizer. It may also be provided that the cooling-medium applicator 6 is a sprinkler nozzle or an ultrasonic evaporator. The cooling medium 20 is applied to the battery pack 10 in the form of a spray mist and/or introduced into the outer housing 12 of the battery pack 10.

In the embodiments, the cooling medium 20 is water, in particular deionized water. However, it may also be provided that the cooling medium 20 is ethanol. When ethanol is used as the cooling medium 20, the apparatus may be operated such that an ethanol vapor concentration in air remains below a lower flammability limit or above an upper flammability limit of ethanol. In particular, the ethanol fraction is at most 3 % by volume or at least 20 % by volume, in particular at least 28 % by volume. It may also be provided that the cooling medium 20 is a liquid based on water or ethanol.

In a fifth method step 45, the cooling medium 20 in the gaseous phase is discharged to the surrounding environment 30. The cooling medium 20 does not circulate, in particular in the apparatus 1, in a closed cooling system. In the embodiments according to FIGS. 1-3, during operation, in particular during charging, the battery pack 10 is arranged in a housing 2 of the apparatus 1. In the fifth method step 45, the cooling medium 20 in the gaseous phase is conducted away from the housing 2. In the embodiments, this is done by means of a blower 3. The blower 3 is arranged in the housing 2. The blower 3 generates an air stream directed out of the housing 2 into the surrounding environment 30. This air stream entrains the cooling medium 20 in the gaseous phase, which is thereby discharged to the surrounding environment 30.

During the fourth method step 44 and/or the fifth method step 45, that is to say after application of the liquid cooling medium 20 onto the battery pack 10, the battery pack 10 is dried. This takes place through the transition of the cooling medium 20 into the gaseous phase and/or by the blower 3. In the second method step 42, the quantity of liquid cooling medium 20 to be applied in the third method step 43 can be determined such that only so much liquid cooling medium 20 is applied onto the battery pack 10 that the drying process is completed before the end of the, in particular complete, charging of the battery pack 10.

In the embodiments according to FIGS. 1-3, method steps 1 to 5 are carried out in and, in particular, by the apparatus 1. The apparatus 1 serves for operating the battery pack 10. The apparatus 1 may be a work apparatus that can be operated by means of the electrical energy of the battery pack 10. It may be provided here that the battery pack 10 can be charged and/or discharged in the work apparatus. Both the withdrawal of electrical energy from the battery pack 10 and the discharging of the battery pack 10 without operating the work apparatus with the energy thereby withdrawn from the battery pack 10, as well as the withdrawal of electrical energy from the battery pack 10 for operation of the work apparatus, count as operation of the battery pack 10. In the embodiments, the apparatus 1 is a charging device which serves for charging and/or discharging of the battery pack 10. For charging and/or discharging, the battery pack 10 can be inserted, in particular slid, into the apparatus 1. After charging, the battery pack 10 can be removed from the apparatus 1.

For electrical connection of the battery pack 10 to the apparatus 1, the apparatus 1 comprises a coupling device 5. The coupling device 5 comprises at least two electrical contact locations. The electrical contact locations can be connected to the electrical contacts 15 of the battery pack 10. In a coupled state of the coupling device 5, the battery pack 10 is electrically coupled to the apparatus 1. The electrical contacts 15 are electrically connected to the coupling device 5.

The apparatus 1 is designed for cooling the battery pack 10 during operation. In the coupled state of the coupling device 5, the cooling medium 20 in the liquid phase can be applied by means of the cooling-medium applicator 6 such that at least part of the cooling medium 20 can evaporate into the gaseous phase due to the heat of the battery pack 10 and the battery pack 10 can thereby be cooled.

The cooling-medium applicator 6 is arranged in the housing 2 of the apparatus 1. In the coupled state, the battery pack 10 is arranged at least partially in the housing 2, in particular in a receiving shaft of the housing 2. The apparatus 1 is designed such that the cooling medium 20 in the gaseous phase can be discharged away from the housing 2 into the environment 30 surrounding the apparatus. This takes place in particular by means of the blower 3 arranged in the housing 2. The blower 3 is also used to dry the battery pack 10 after application of the liquid cooling medium 20.

As shown schematically in FIGS. 1-3, the apparatus 1 comprises a control unit 7. The apparatus 1 is designed such that, in the coupled state, the control unit 7 receives information concerning the state of charge of the battery pack 10 and the temperature of the battery pack 10. From the state of charge and the temperature, the control unit 7 determines a maximum volume of cooling medium 20 which at most may be applied onto the battery pack 10 such that the battery pack 10, in particular under the action of the blower 3, is completely dry before it is fully charged. The control unit 7 controls the cooling-medium applicator 6 such that it applies the determined maximum volume of cooling medium 20 onto the battery pack 10. It may also be provided that, from the state of charge and the temperature, the control unit 7 determines a maximum volume of cooling medium 20 which at most may be applied onto the battery pack 10 such that the battery pack 10, in particular under the action of the blower 3, is completely dry before it is fully discharged.

The exemplary embodiments according to FIGS. 1-3 can be combined with one another. In particular, use of the battery pack from the exemplary embodiment according to FIG. 3 may be provided in the apparatus 1 according to the exemplary embodiment of FIG. 2.

What is claimed is:

1. A method for operating a battery pack (10) configured to provide energy, the battery pack (10) including an outer housing (12) and at least one battery cell (11) arranged in the outer housing (12), the method comprising:
operating the battery pack (10) such that heat is generated in the battery pack (10);
bringing a cooling medium (20) in a liquid phase into direct contact with the outer housing (12) of the battery pack (10);
cooling the battery pack (10) by vaporizing at least a portion of the cooling medium (20) using heat transferred from the battery pack (10).

2. The method of claim 1, further comprising discharging the cooling medium (20) in a gaseous phase to a surrounding environment (30).

3. The method of claim 1,
further comprising arranging the battery pack (10) in or on a housing (2) during operation of the battery pack (10), and
conducting the cooling medium (20) in a gaseous phase away from the housing (2).

4. The method of claim 3, further comprising discharging the cooling medium (20) in the gaseous phase to a surrounding environment (30) using a blower (3).

5. The method of claim 1, further comprising drying the battery pack (10) after applying the cooling medium (20) in the liquid phase to the outer housing (12) of the battery pack (10).

6. The method of claim 1, further comprising applying the cooling medium (20) in the liquid phase directly onto the at least one battery cell (11).

7. The method of claim 1, wherein an outer surface (14) of the outer housing (12) of the battery pack (10) is hydrophilic, uneven, or both, such that the outer surface (14) provides an enlarged cooling surface having a surface area greater than a surface area of a flat and smooth reference surface having the same outer dimensions as the outer surface (14).

8. The method of claim 1, further comprising atomizing the cooling medium (20) before bringing the cooling medium (20) into direct contact with the outer housing (12) of the battery pack (10).

9. The method of claim 1, further comprising determining a temperature of the battery pack (10), and bringing the cooling medium (20) into contact with the battery pack (10) only when the determined temperature exceeds a predetermined threshold temperature.

10. The method of claim 1, further comprising determining a temperature of the battery pack (10), and adapting a quantity of the cooling medium (20) used for cooling based on the determined temperature of the battery pack (10).

11. The method of claim 1, wherein the cooling medium (20) comprises water, ethanol, a water-based liquid, or an ethanol-based liquid.

12. An apparatus for operating a battery pack (10), the apparatus (1) comprising:
a coupling device (5) configured to electrically couple the battery pack (10) to the apparatus (1); and
a cooling-medium applicator (6) configured to apply a cooling medium (20) in a liquid phase directly onto the battery pack (10) while the battery pack (10) is electrically coupled to the apparatus (1),
wherein the cooling-medium applicator (6) is configured to apply the cooling medium (20) such that heat generated by the battery pack (10) causes at least a portion of the cooling medium (20) to vaporize into a gaseous phase, thereby cooling the battery pack (10).

13. The apparatus of claim 12,
wherein the battery pack (10) includes an outer housing (12) and at least one battery cell (11) arranged in the outer housing (12), and
wherein the cooling-medium applicator (6) is configured to apply the cooling medium (20) in the liquid phase directly onto the outer housing (12) of the battery pack (10) while the battery pack (10) is electrically coupled to the apparatus (1).

14. The apparatus of claim 12,
further comprising a housing (2),
wherein the cooling-medium applicator (6) is arranged on or in the housing (2),
wherein the battery pack (10) is arranged in or on the housing (2) while electrically coupled to the apparatus (1), and
wherein the apparatus (1) is configured to discharge the cooling medium (20) in the gaseous phase away from the housing (2) into a surrounding environment (30).

15. The apparatus of claim 12, further comprising a blower (3) configured to discharge the cooling medium (20) in the gaseous phase to the surrounding environment (30).

16. The apparatus of claim 15, wherein the blower (3) is configured to dry the battery pack (10) after the cooling-medium applicator (6) applies the cooling medium (20) in the liquid phase to the battery pack (10).

17. The apparatus of claim 12, further comprising a control unit (7) configured
to receive, while the battery pack (10) is electrically coupled to the apparatus (1), information indicating a state of charge of the battery pack (10) and a temperature of the battery pack (10), and
to determine, based on the state of charge and the temperature, a maximum volume of the cooling medium (20) to be applied to the battery pack (10) so that the battery pack (10) is dry before the battery pack (10) is fully charged or fully discharged.

18. The apparatus of claim 17, wherein the control unit (7) is configured to control the cooling-medium applicator (6) to apply no more than the maximum volume of the cooling medium (20) to the battery pack (10).

19. The apparatus of claim 12, wherein the cooling medium (20) comprises water, ethanol, a water-based liquid, or an ethanol-based liquid.
